(19) United States
(12) Patent Application Publication
(10) Pub. No.: US 2006/0204000 A1
(43) Pub. Date: Sep. 14, 2006

(54) Mobile communications device carrier with vibrate ring

(75) Inventors: Nicholas K. Eisner, Ben Lomond, CA (US); Jack A. Reynolds, Santa Cruz, CA (US)

Correspondence Address: PLANTRONICS, INC., 345 ENCINAL STREET, P.O. BOX 635, SANTA CRUZ, CA, 95060-0635, US

(73) Assignee: Plantronics, Inc.

(21) Appl. No.: 11/345,150

(22) Filed: Feb. 1, 2006

Related U.S. Application Data
(60) Provisional application No. 60/660,247, filed on Mar. 9, 2005.

(51) Int. Cl. H04M 1/00

(52) U.S. Cl. 379/433.01

(57) ABSTRACT

Systems and methods for a carrier for a mobile communications device are disclosed. The system generally includes a vibrate motor assembly and one or more contact interfaces.

### CROSS REFERENCE TO RELATED APPLICATIONS

This application claims priority to Provisional Patent Application 60/660,247, entitled “MOBILE COMMUNICATIONS DEVICE CARRIER WITH VIBRATE RING,” to Nicholas K. Eisner and Jack Reynolds, and filed Mar. 9, 2005.

### BACKGROUND OF THE INVENTION

Carriers for mobile communication devices such as headsets generally provide two important functions. First, the headset carrier provides protected storage for the headset when the headset is not in use. Second, the headset carrier typically has a charging interface allowing the carrier to be connected to a power source to provide charging power to the headset while it is stored.

Users of mobile telephones are accustomed to receiving an audible ring to notify the user of an incoming call on the phone. Alternatively, the mobile telephone may be equipped with a vibrate ring function comprising a vibrating assembly that causes the mobile phone to vibrate to alert the user to an incoming call.

Recently, a headset usage pattern has arisen where it would be useful for the headset to inform the user of an incoming call. For example, such functionality is useful in wireless headset applications. In the prior art, such notification is typically provided by a speaker at the headset. However, this solution is problematic since the headset speaker may not provide sufficient loudness to notify the user if it is stored in a headset carrier.

As a result, there is a need for improved methods and apparatuses for call notification in headset carriers and headsets.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a perspective view of a headset carrier in one example of the invention.

FIG. 2 illustrates a disassembled perspective view of the headset carrier shown in FIG. 1.

FIG. 3 illustrates a disassembled perspective view of a component of the headset carrier.

FIG. 4 illustrates fabrication of a component of the headset carrier.

FIG. 5 illustrates an example of a charging interface which is used with the headset carrier.

FIG. 6 illustrates an alternate perspective view of the charging interface shown FIG. 5.

FIG. 7 illustrates a charging cable with a male plug connector coupled with the charging interface shown in FIG. 5.

FIG. 8 illustrates a backside internal view of the charging interface shown in FIG. 5 coupled with a male plug.

FIG. 9 illustrates a headset inserted into a carrier in one example of the invention.

### DESCRIPTION OF SPECIFIC EMBODIMENTS

Methods and apparatuses for carriers for mobile communication devices such as headsets are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

Generally, this description describes a method and apparatus for a carrier for a headset with a vibrate ring function. The present invention is applicable to a variety of different types of headsets, and has been found to be particularly suited for wireless headsets. For example, the carrier described herein may be used with a wireless headset using Bluetooth technology. While the present invention is not necessarily limited to such devices, various aspects of the invention may be appreciated through a discussion of various examples using this context.

According to an example embodiment of the present invention, a carrier for a headset includes a vibrate ring motor to implement a vibrate ring function. The vibrate ring motor results in enhanced functionality of the carrier. In one example mode of operation, the vibrate ring motor may receive power from the headset being stored in the carrier.

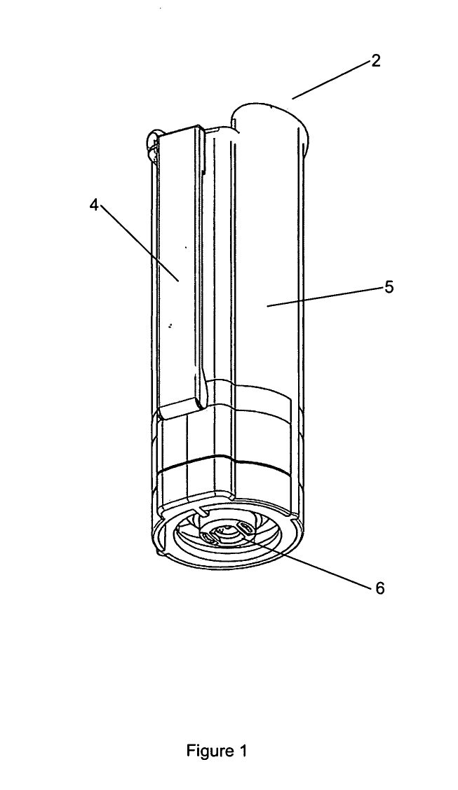

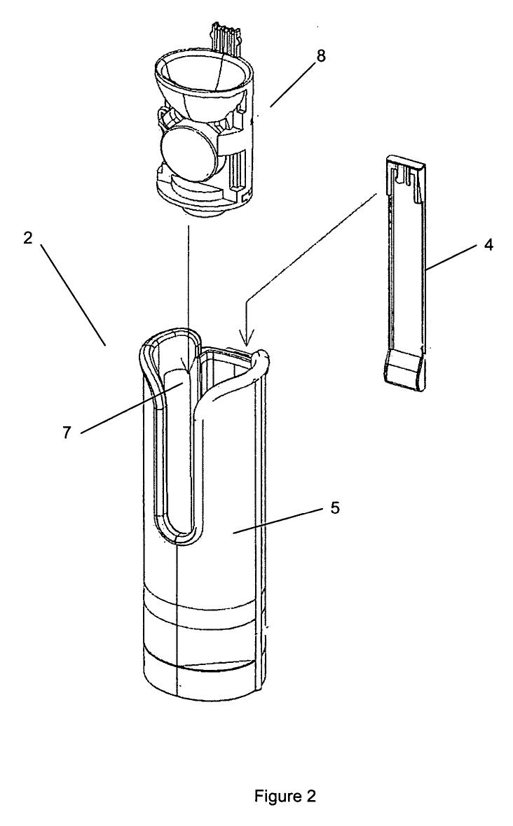

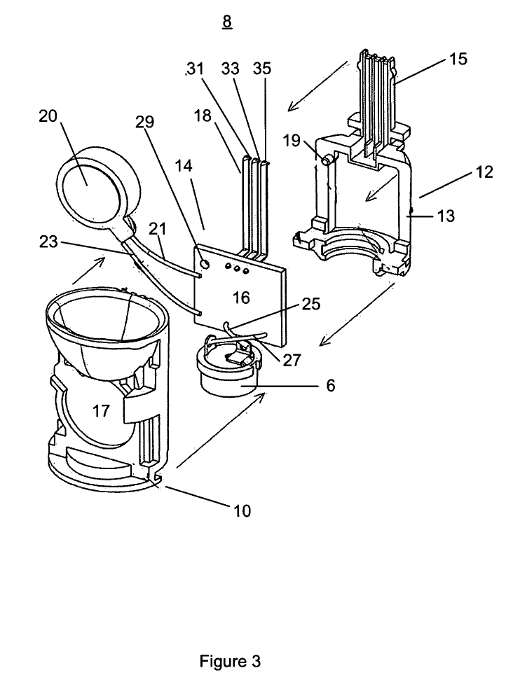

FIG. 1 illustrates a perspective view of a headset carrier 2 (also referred to by the inventors as a “pocket”) in one example of the invention. Carrier 2 includes a carrying clip 4, outer shell 5 with a receptacle for receiving a headset, and a power interface 6. The terms shell, housing, and cover may be used interchangeably throughout the disclosure. Carrier 2 includes internal components (not shown), which are encapsulated within shell 5 and described below in reference to FIG. 2 and FIG. 3.

Referring to FIG. 2, a disassembled perspective view of the carrier 2 shown in FIG. 1 is illustrated. Carrier 2 includes a motor and contact assembly 8, outer shell 5 with a receptacle, and carrying clip 4.

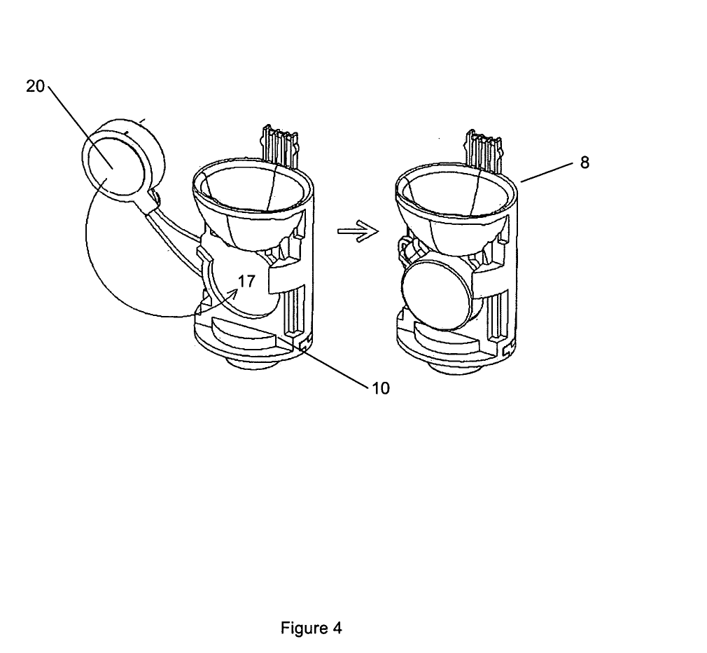

FIG. 3 illustrates a disassembled perspective view of the motor and contact assembly 8. The motor and contact assembly 8 includes a contact block 12, printed circuit board (PCB) assembly 14, and cover 10. An exemplary method of assembling motor and contact assembly 8 will be explained with reference to FIG. 3 and FIG. 4.

Referring to FIG. 3, contact block 12 includes a shell 13 forming one half of a housing for PCB assembly 14. Contact block 12 further includes ribs 15 for mating with associated electrical contacts on PCB assembly 14. PCB assembly 14 includes a PCB 16, motor assembly 20, and power interface 6. Cover 10 forms a second half of a housing for PCB assembly 14, and further includes an outward exterior surface 17 to which motor assembly 20 is mated.

Motor assembly 20 is electrically connected to PCB 16 by wire 21 and wire 23. Wire 21 is connected to a positive electrical contact element and wire 23 is connected to a negative electrical contact element. In one example, wire 21 and wire 23 are connected directly to the positive and negative leads, respectively, of the motor assembly 20 by soldering or other method of connection. Wires 21 and 23 are made of an electrically conductive material such as copper, for example. Wires 21 and 23 are sufficiently flexible that vibrations from motor assembly 20 do not propagate through the wires into PCB 16.

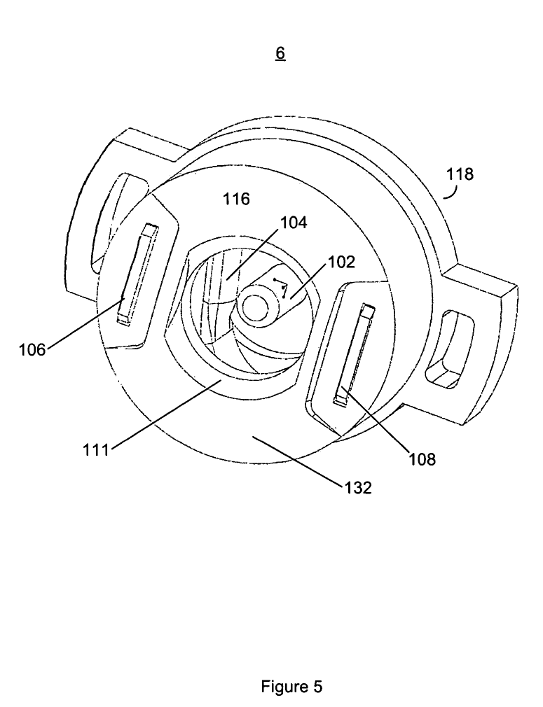

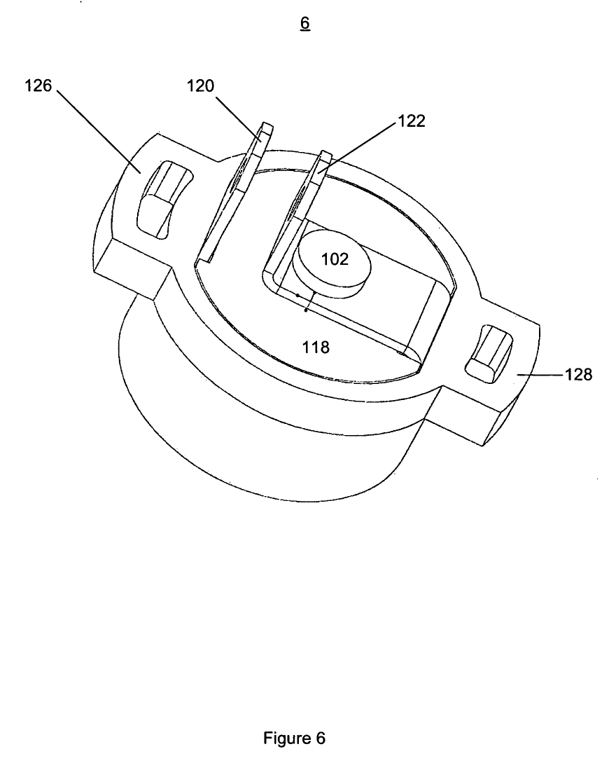

Power interface 6 is electrically connected to PCB 16 by wire 25 and wire 27. Wires 25 and 27 are made of an electrically conductive material, such as copper. Power interface 6 in one example form is described in reference to FIG. 5 and FIG. 6 below.

Electrical contacts 18 are preferably made from a suitable electrically conductive metal such as, for example, copper. PCB 16 includes electrical connections positioned to correspond with electrical contacts 18. Electrical contacts 18 are secured to PCB 16 at the corresponding electrical connections on PCB 16. In one example, electrical contacts 18 include contacts 31, 33, and 35. Contacts 31 and 33 provide transfer of electrical power either from the carrier 2 to a battery at the headset or from the headset battery to the carrier 2. Contact 35 transfers an electrical signal, such as a vibrate ring signal, from the headset to the carrier 2. PCB 16 further includes electrical connections to which wires 21 and 23 from motor assembly 20 and wires 25 and 27 from power interface 6 are connected. PCB assembly 14 is connected to shell 13 by securing dowel 19 through aperture 29 on PCB 16. Securing dowel 19 presses contacts 18 and ribs 15 together, thereby providing a secure electrical interface for use with an associated interface located on a headset.

It will be appreciated that numerous other configurations exist for establishing an electrical connection between motor assembly 20 and PCB 16 as well as between PCB 16 and power interface 6. The particular mechanism for establishing electrical contact between these components is not critical to the present invention.

PCB 16 includes circuitry for transferring electrical power between power interface 6 and motor assembly 20, power interface 6 and contacts 18, and contacts 18 and motor assembly 20. PCB 16 further includes circuitry for receiving and processing a vibrate signal from contacts 18 to actuate motor assembly 20.

In the assembly of motor and contact assembly 8, PCB 16 and power interface 6 are secured between shell 13 and cover 10. For example, a dowel 19 may be used. Referring to FIG. 4, motor assembly 20 is secured to outward exterior surface 17 of cover 10 using glue or a suitable mechanical fastener. Securing motor assembly 20 to outward exterior surface 17 enables vibrations from the motor assembly to propagate through the outer shell 5 of carrier 2 (FIG. 1) such that a user can readily detect the vibration alert. In the assembly of a carrier 2, an outer shell 5 is provided. Outer shell 5 may also be referred to as a cover or housing. Outer shell 5 may include front and back cover components which are connectable by suitable mechanical connectors. For example, such mechanical connectors may include screws, rivets or snap-fit connectors. Referring to FIG. 2, outer shell 5 includes an aperture 7 for receiving motor and contact assembly 8 during assembly. Motor and contact assembly 8 may be secured within outer shell 5 using glue or a suitable mechanical fastener. Suitable fasteners include screws, rivets, grommets, or other fastening means known in the art. Assembly of carrier 2 may then be completed by securing the carrying clip 4 to the outer shell 5.

Motor assembly 20 may, for example, utilize a flat type vibration motor. The flat type vibration motor includes a stator assembly as a stationary member and a rotor assembly as a rotary member. In operation, the vibrator motor drives a rotating shaft having a center of mass displaced from the axis of rotation, thereby causing a vibration when the shaft rotates. However, other types of vibration of motors may be employed in further examples of the invention, such as cylinder type vibration motor. Illustrative examples of vibrate motor assemblies are disclosed, for example, in U.S. Pat. No. 6,828,705.

In operation, a user may store a wireless headset in carrier 2 during non-use. In one mode of operation, the headset transfers a vibrate ring signal to carrier 2 via contacts 18 when a call is received. For example, the vibrate ring signal may be transferred using a Bluetooth link from a mobile phone to the headset. The vibrate ring signal is received at PCB 16, which responsively transfers electrical power to motor assembly 20. The motor assembly 20 is thereby actuated, transferring vibrations to the outer shell 5 to vibrate the carrier 2 to notify a user of the incoming call. Electrical power for motor assembly 20 may be received from the battery in the headset via contacts 18. Electrical power for motor assembly 20 may also be received from a power source through power interface 6. In a further mode of operation, carrier 2 may be coupled to an electrical power source using power interface 6.

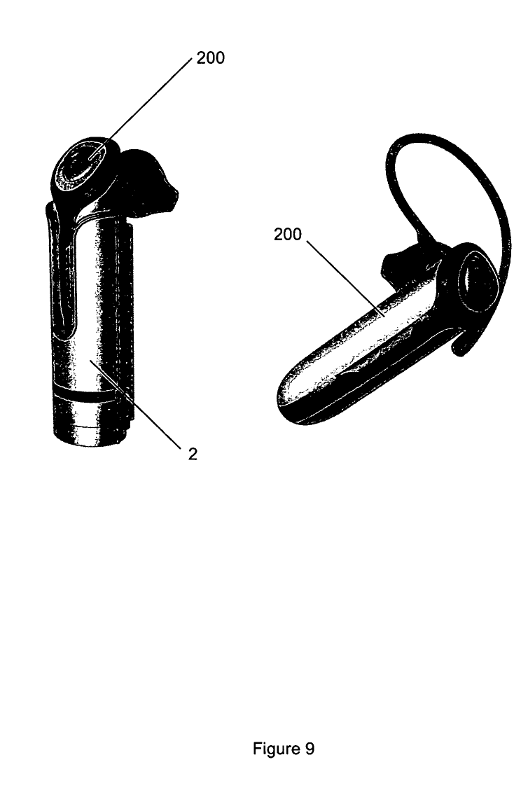

Charging power received from power interface 6 is transferred to a battery in the wireless headset through contacts 18. Charging power received from power interface 6 may be used to provide power to motor assembly 20. Referring to FIG. 9, a headset 200 is shown stored in carrier 2. The shape of headset 200 may take other forms in additional embodiments.

Referring to FIG. 5, a front view illustration of an embodiment of a power interface 6 for use with carrier 2 in one example is shown. Carrier 2 may also use other charging interface structures to perform the functions of transferring electrical power described herein. The power interface 6 is shown removed from a carrier. In use, for example, the front surface of the charging interface is exposed at the base of the carrier, as shown FIG. 1.

The power interface 6 comprises an outer housing 132 having a front surface 116 and a back surface 118. Outer housing 132 is made of a molded polymer, although any suitable material may be used. Front surface 116 contains an aperture 114 opening to a well 134 located within outer housing 132 for accepting a male plug. Front surface 116 further contains a semi-spherical recessed area 111. Two surface charging contacts, negative contact arc 106 and positive contact arc 108 are disposed on front surface 116. The power interface 6 further comprises a negative contact 104 and a positive contact 102 disposed within well 134. Although referred to with different designations herein, in an embodiment of the invention, negative contact 104 and negative contact arc 106 are a single piece construction and electrically parallel. Similarly, positive contact 102 and positive contact 108 are a single piece construction and electrically parallel. The negative contact and the positive contact are made of a suitable electrically conductive material such as copper.

The power interface 6 is mounted from inside the carrier housing and presents an approximately 6.5 mm diameter plastic face with slightly raised metal negative contact arc 106 and positive contact arc 108 arrayed around aperture 114. For appearance purposes, the module is mounted so that the face is as flush as possible to the exterior surface of the carrier housing. The contact arcs are proud of the surface by about 0.1 mm to 0.2 mm in an embodiment of the invention. In an embodiment of the invention, the contact arcs are concentric shaped. In a further embodiment of the invention, the contact arcs may be linear, as shown in FIG. 5.

The power interface 6 includes two charging interfaces. The first charging interface utilizes stationary charging contacts comprising negative contact arc 106 and positive contact arc 108 disposed on front surface 116. Negative contact arc 106 and positive contact arc 108 mate with corresponding contacts on a charging base when a carrier is inserted into or mated with the base. The corresponding contacts on the charging base are typically spring loaded, and engage negative contact arc 106 and positive contact arc 108 when the carrier is inserted into the charging base. Negative contact arc 106 is coupled to electrical ground. In an embodiment of the invention, the first charging interface further utilizes recessed area 111 and aperture 114 to secure contact between negative contact arc 106 and positive contact arc 108 with corresponding charging contacts on a charging base. This embodiment is described in further detail below.

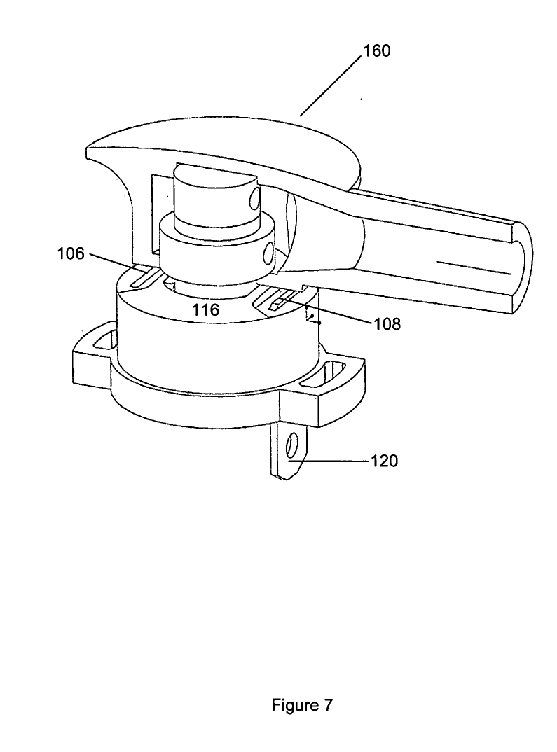

The second charging interface comprises a negative contact 104 and positive contact 102 disposed within well 134 behind aperture 114. The second charging interface operates as a female connector for use with a cable having a male charging plug. In an embodiment of the invention, negative contact 104 is a spiral coil contact positioned within well 134 that engages the inserted cable having a male charging plug. Positive contact 102 is a pin structure disposed in the center of well 134 that inserts into a corresponding positive contact receptacle of the male charging plug. Positive contact 102 and negative contact 104 mate with a male charging plug of cable 160 shown in FIG. 7. A cutaway view of cable 160 with its corresponding boot is shown in FIG. 7.

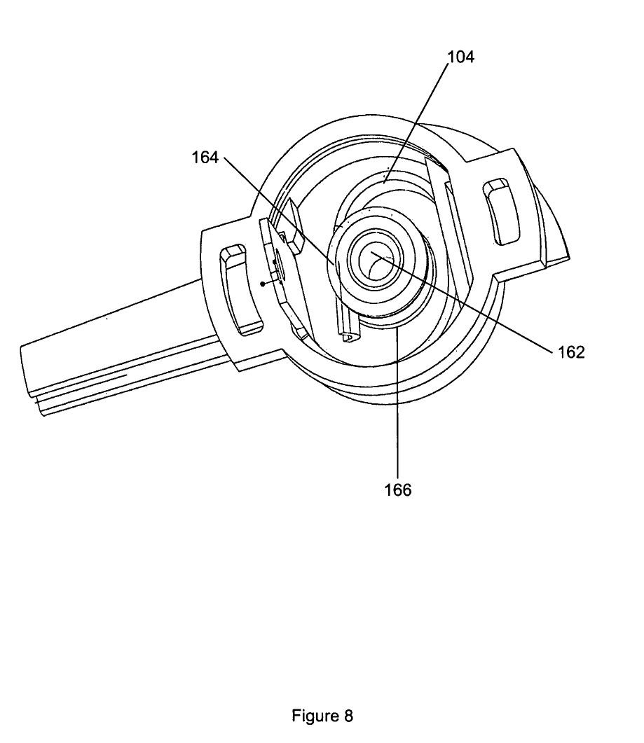

Referring to FIG. 6 showing the backside of power interface 6, the bottom surface 122 of positive contact 102 is shown. Referring to FIG. 8, illustrated is a cable with a cylindrical male plug 166 with interior positive contact 162 and exterior negative contact 164. Interior positive contact 162 itself has a female connector. Interior positive contact 162 has a female connector constructed to receive and mate with positive contact 102 of power interface 6. For clarity, positive contact 102 is not shown in FIG. 8. Exterior negative contact 164 has a flanged outer surface constructed to couple with negative contact 104 of power interface 6.

In operation, the cylindrical male plug 166 is inserted through aperture 114 into well 134. Positive contact 102 of power interface 6 fits into the female connector of interior positive contact 162 to form an electrical interconnection. During insertion of male plug 166, negative contact 104 of power interface 6 extends in an outward radial direction due to force from exterior negative contact 164. Negative contact 104 then retracts into the flanged outer surface of negative contact 164 as male plug 166 is further inserted into well 134 to a detent position. Referring to FIG. 8, negative contact 104 of power interface 6 is shown mated in a detent position with exterior negative contact 164 of cable 160 after insertion of cable 160 into well 134.

Cable 160 delivers a current for delivery to charge a headset battery or to power a vibrate motor assembly via positive charging contact 102. Negative terminal 120 is coupled to electrical ground. Thus, power interface 6 utilizes aperture 114 in both the first charging interface and the second charging interface. By utilizing the aperture 114 in both charging interfaces, the area required by power interface 6 is minimized.

Referring to FIG. 6, the backside of outer housing 132 is shown. Outer housing 132 includes a back surface 118. A negative terminal 120 and positive terminal 122 are utilized to provide electrical power. In an embodiment of the invention, negative contact 104, negative contact arc 106, and negative terminal 120 are a single piece construction. Similarly, positive contact 102, positive contact arc 108, and positive terminal 122 are a single piece construction. The electrically parallel first charging interface and second charging interface provide an efficient and space saving arrangement to provide charging power to a headset rechargeable battery through carrier 2 or to provide electrical power to a motor assembly 20. In an alternate embodiment, although electrically coupled, negative contact 104, negative contact arc 106, and negative terminal 120 are not a single piece construction. Similarly, in an alternate embodiment, positive contact 102, positive contact arc 108, and positive terminal 122 are not a single piece construction. Positive contact 102 extends through positive terminal 122 and back surface 118 into well 134.

As a result, electrical power is provided to a battery or to a vibrate motor assembly regardless of which charging interface is utilized. Outer housing 132 further includes headset mounting handles 126 and 128 for mounting power interface 6 within a carrier 2. The power interface 6 may be manufactured as a stand-alone module, and has the packaging flexibility allowing for either board or cable mounting.

The various examples described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such changes may include, but are not necessarily limited to: the method of assembling the various carrier components, the fasteners or glues used in assembly, and the shape of the shells or housings. Furthermore, the shapes, locations, and sizes of the illustrated carrier and various components may be altered. In particular, various contact structures or power interfaces may be used in additional examples of the invention. Such modifications and changes do not depart from the true spirit and scope of the present invention that is set forth in the following claims.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1. A carrier for a mobile communications device comprising:
a housing forming a receptacle for receiving a mobile communications device;
a vibrate motor;
a first contact interface system for receiving electrical power; and
a second contact interface system for coupling to a corresponding mobile communications device contact interface.

2. The carrier of claim 1, wherein the vibrate motor receives electrical power from the mobile communications device through the second contact interface system.

3. The carrier of claim 1, wherein the vibrate motor is actuated following receipt of a vibrate ring signal through the second contact interface system.

4. The carrier of claim 1, wherein the mobile communications device includes a Bluetooth transceiver.

5. The carrier of claim 1, wherein the mobile communications device comprises a wireless headset.

6. The carrier of claim 1, further comprising a carrying clip coupled to the housing.

7. The carrier of claim 1, further comprising a printed circuit board providing electrical connections between the vibrate motor, first contact interface system, and second contact interface system for transferring electrical power.

8. The carrier of claim 1, further comprising a printed circuit board coupled to the second contact interface system for transferring a vibrate ring signal.

9. The carrier of claim 1, wherein the vibrate motor is a flat-type vibration motor.

10. The carrier of claim 1, wherein the first contact interface system comprises:
a wiping contact interface comprising a first linear or arc contact and a second linear or arc contact; and
a plug interface for receiving a male plug, the plug interface comprising a spring coil contact and a pin contact, wherein the spring coil contact is coupled to the first linear or arc contact and the pin contact is coupled to the second linear or arc contact.

11. A method for indicating an incoming call comprising:
providing a mobile communications device stored in a carrier, wherein the carrier comprises a vibrate ring motor;
receiving a vibrate ring signal at the mobile communications device;
transferring the vibrate ring signal from the mobile communications device to the carrier via a contact interface system;
responsively actuating the vibrate ring motor to indicate an incoming call.

12. The method of claim 11, further comprising transferring electrical power from the mobile communications device to the carrier via the contact interface system to power the vibrate ring motor.

13. The method of claim 11, further comprising providing electrical power to the vibrate ring motor from a carrier power interface system.

14. A carrier for a mobile communications device comprising:
a housing means for receiving a mobile communications device;
a vibrator means for generating vibrations which propagate through the housing;
a first contact interface means for receiving electrical power; and
a second contact interface means for coupling to a corresponding mobile communications device contact interface.

15. The carrier of claim 14, wherein the vibrator means receives electrical power from the mobile communications device through the second contact interface means.

16. The carrier of claim 14, wherein the vibrator means is actuated following receipt of a vibrate ring signal through the second contact interface means.

17. The carrier of claim 14, wherein the mobile communications device includes a wireless transceiver means for receiving a vibrate ring signal.

18. The carrier of claim 14, wherein the mobile communications device comprises a wireless headset.

19. The carrier of claim 14, further comprising a carrying means coupled to the housing.

20. The carrier of claim 14, further comprising a circuit means for transferring electrical power between the vibrate motor, first contact interface system, and second contact interface system.

21. The carrier of claim 14, further comprising a circuit means coupled to the second contact interface means for transferring a vibrate ring signal.
